(19) United States
(12) Patent Application Publication
(10) Pub. No.: US 2022/0046847 A1
(43) Pub. Date: Feb. 17, 2022

(54) DRAFT CONTROL MECHANISM FOR AN IMPLEMENT COUPLED TO VEHICLE HITCH

(71) Applicant: MAHINDRA & MAHINDRA LIMITED, Mohali (IN)

(72) Inventor: Vikas Singh, Mohali (IN)

(21) Appl. No.: 17/275,436

(22) PCT Filed: Sep. 12, 2019
(86) PCT No.: PCT/IN2019/050667

§ 371 Date: Mar. 11, 2021

(30) Foreign Application Priority Data
Sep. 12, 2018 (IN) 201811034476

(51) Int. Cl. A01B 63/112; B60D 1/24; B60D 1/42

(52) U.S. Cl. CPC A01B 63/112; B60D 1/42; B60D 1/249

(57) ABSTRACT

Draft control mechanism (400) for an implement coupled to vehicle hitch (50) is provided. Draft control mechanism (400) includes a sliding assembly (402), a first end cover (404), a housing (406), a second end cover (407), at least one resilient and shock absorber arrangement 408 and an adjustable assembly (410). The first end cover (404) is connected to housing (406). The second end cover (407) is connected to the housing (406) and disposed opposite to the first end cover (404). The resilient and shock absorber arrangement (408) is adapted to dampen a shock load received by the implement. The resilient and shock absorber arrangement (408) is provided between sliding assembly (402), and at least one of second end cover (407) and adjustable assembly (410). At least one of the adjustable assembly (410) and the sliding assembly (402) is configured to be moved with respect to the housing (406) to vary the draft of the implement.

### CROSS REFERENCE TO RELATED APPLICATION

This application is based on and derives the benefit of Indian Application 201811034476 filed on 12 Sep. 2018, the contents of which are incorporated herein by reference.

### TECHNICAL FIELD

The embodiments herein relate to a draft control mechanism for an agricultural implement coupled to an implement mounting structure (hitch) of a vehicle.

### BACKGROUND

Vehicles such as tractors and other similar vehicles are primarily used in agricultural field operations. One of the most common uses of agricultural tractors is to move an agricultural implement through agricultural fields to condition the soil for cultivation. Usually, the agricultural implements are attached to a rear-end and/or a front-end of the vehicle using a hitch or a drawbar depending on the type of vehicle configuration and the type of field operation (work) that is to be carried out in the agricultural fields. A Draft control mechanism of a vehicle is used for controlling the draft of the agricultural implement to regulate corresponding depth operation of the agricultural implement in agricultural fields. Most of the agricultural implements are heavy weight implements which attains desired depth of operation by their own weight. However, the heavy weight implements are difficult to handle in the agricultural fields, increases an overall weight of the vehicle and incurs high cost due to the heavy weight of the agricultural implement. On the other hand, light weight implements are easy to handle and cost effective. However, light weight implements cannot attain desired depth of operation in agricultural fields due to the light weight of the agricultural implement. The agricultural implements are subjected to shock loads when the agricultural implement is towed by the vehicle in agricultural fields. The shock loads received by the agricultural implement is undesirable. Hence, there is a requirement to absorb the shock loads received by the implement to restrict wear and tear of the components in position and draft mechanism to prevent the failure of the system.

Conventional electro-hydraulic draft control mechanism enables precise adjustment in draft of the agricultural implement. However, the electro-hydraulic draft control mechanism is complex in design and incurs high cost.

Therefore, there exists a need for a draft control mechanism for an agricultural implement coupled to an implement mounting structure (hitch) of a vehicle, which obviates the aforementioned drawbacks.

### OBJECTS

The principal object of an embodiment of this invention is to provide a draft control mechanism for an agricultural implement coupled to a implement mounting structure (hitch) of a vehicle, which is used to vary the draft of the agricultural implement, and to dampen a shock load received by the agricultural implement.

Another object of an embodiment of this invention is to provide a draft control mechanism for an agricultural implement coupled to an implement mounting structure (hitch) of a vehicle, which varies the draft of the agricultural implement in accordance to various types of implements and various types of agricultural field operations.

Yet, another object of an embodiment of this invention is to provide a draft control mechanism for an agricultural implement coupled to an implement mounting structure (hitch) of a vehicle, which comprises a resilient and shock absorber arrangement adapted to dampen a shock load received by the agricultural implement.

A further object of an embodiment of this invention is to provide a draft control mechanism for controlling the draft of alight weight agricultural implement coupled to an implement mounting structure (hitch) of a vehicle, which enables the attached light weight agricultural implement to attain desired depth operation in agricultural fields.

These and other objects of the embodiments herein will be better appreciated and understood when considered in conjunction with the following description and the accompanying drawings. It should be understood, however, that the following descriptions, while indicating embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The embodiments of the invention are illustrated in the accompanying drawings, throughout which like reference letters indicate corresponding parts in the various figures. The embodiments herein will be better understood from the following description with reference to the drawings, in which:

FIG. 1 depicts an exploded view of a draft control mechanism, according to an embodiment of the invention as disclosed herein; and

FIG. 2 depicts a cross-sectional view of the draft control mechanism, according to an embodiment of the invention as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

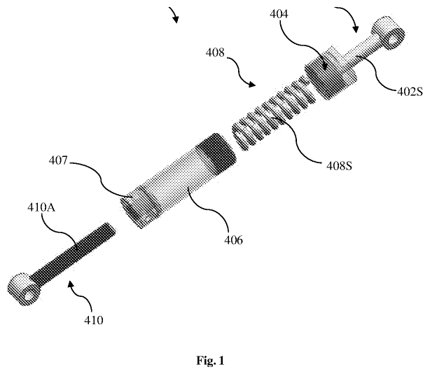

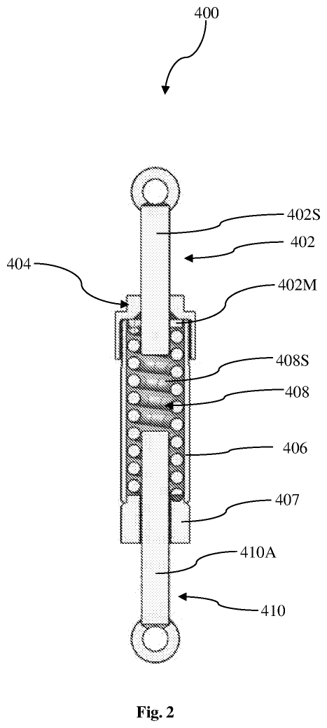

The embodiments herein achieve a draft control mechanism for an agricultural implement coupled to an implement mounting structure (hitch) of a vehicle, which is used to vary the draft of the agricultural implement, and to dampen a shock load received by the agricultural implement. Referring now to the drawings, and more particularly to FIGS. 1 through 2, where similar reference characters denote corresponding features consistently throughout the figures, there are shown embodiments.

FIG. 1 depicts an exploded view of a draft control mechanism 400, according to an embodiment of the invention as disclosed herein. FIG. 2 depicts a cross-sectional view of the draft control mechanism 400, according to an embodiment of the invention as disclosed herein. In an embodiment, the draft control mechanism 400 is used to vary the draft of the implement and to dampen a shock load received by the implement when the implement is being towed by the vehicle in agricultural fields. The draft control mechanism 400 is also called as top link draft control apparatus. In an embodiment, the draft control mechanism 400 comprises a sliding assembly 402, a first end cover 404, at least one housing 406, a second end cover 407, at least one resilient and shock absorber arrangement 408 and an adjustable assembly 410. For the purpose of this description and ease of understanding, the draft control mechanism 400 is explained herein below with reference to be provided in an agricultural vehicle. However, it is also within the scope of the invention to implement/practice the draft control mechanism 400 in an off-road vehicle, an agricultural harvester and/or any other type of vehicle without otherwise deterring the intended function of the draft control mechanism 400 as can be deduced from the description and corresponding drawings.

The sliding assembly 402 is slidably engaged with the first end cover 404 and supports corresponding end of at least one resilient and shock absorber arrangement 408. The sliding assembly 402 is adapted to be at least partially and slidably received inside the housing 406. In an embodiment, the sliding assembly 402 includes at least one sliding member 402S and at least one support member 402M. The sliding assembly 402 is adapted to be at least partially and slidably connected to the first end cover 404. For the purpose of this description and ease of understanding, the sliding member 402S of the sliding assembly 402 is at least partially and slidably connected to the first end cover 404. The sliding member 402S of the sliding assembly 402 is at least a sliding tie rod. It is also within the scope of the invention to provide the sliding member 402S in form of a sliding tie tube. The support member 402M of the sliding assembly 402 is adapted to be connected to the sliding element 402S to support corresponding end of the resilient and shock absorber arrangement 408. The support member 402M of the sliding assembly 402 is also called as a resilient and shock absorber support member or spring support member. The sliding movement of the sliding member 402S with the first end cover 404 enables the support member 402M of the sliding assembly 402 to compress corresponding at least one resilient and shock absorber arrangement 408 which in turn dampens a shock load received by the implement.

In another embodiment, the sliding assembly (402) is an adjustable sliding assembly (402) which comprises a rotatable center member (not shown), at least one adjustable member (not shown), at least one adjustable sliding member (not shown) and at least one support member (not shown). The rotatable center member (not shown) is between the adjustable member (not shown) and the adjustable sliding member (not shown) of the adjustable sliding assembly (402). The adjustable member (not shown) of the adjustable sliding assembly (402) is adapted to be at least partially and movably connected to the rotatable center member (not shown) of the adjustable sliding assembly (402). The adjustable sliding member (not shown) of the adjustable sliding assembly (402) is adapted to be at least partially and movably connected to the rotatable center member (not shown), and at least partially and slidably connected to the first end cover (404). The adjustable sliding member (not shown) is opposite to the adjustable member (not shown) of the adjustable sliding assembly (402). The support member (not shown) of the adjustable sliding assembly (402) is adapted to be connected to the adjustable sliding member (not shown) to support corresponding end of the resilient and shock absorber arrangement (408). To vary the draft of the implement, the rotatable center member (not shown) is configured to be moved to move the adjustable member (not shown) and the adjustable sliding member (not shown) with respect to the rotatable center member (not shown) to vary the draft of the implement. The adjustable sliding assembly (402) includes at least one locking element (not shown) for locking the position of the adjustable member (not shown) and the adjustable sliding member (not shown) at corresponding adjusted positions (adjusted length) to lock the adjustable sliding assembly (402) at corresponding position (adjusted length), where the locking element (not shown) is at least one of a threaded nut, a threaded ring, a threaded fastener, a threaded insert, a locking pin and a combination of the above. The sliding movement of the adjustable sliding member (not shown) of the adjustable sliding assembly (402) with the first end cover (404) enables corresponding at least one support member (not shown) of the adjustable sliding assembly (402) to compress corresponding at least one resilient and shock absorber arrangement (408) which in turn dampens the shock load received by the implement. In an embodiment, the rotatable center member (not shown) of the adjustable sliding assembly (402) is at least one of a rotatable center outer tube and a rotatable center outer rod, and correspondingly the adjustable member (not shown) is at least one of an adjustable inner tie rod and an adjustable inner tie tube, and the adjustable sliding member (not shown) is at least one of an adjustable inner sliding rod and an adjustable sliding inner tube. In another embodiment, the rotatable center member of the adjustable sliding assembly (402) is at least one of a rotatable center inner tube and a rotatable center inner rod, and correspondingly the adjustable member (not shown) is at least one of an adjustable outer tie rod and an adjustable outer tie tube, and the adjustable sliding member (not shown) is at least one of an adjustable outer sliding rod and an adjustable sliding outer tube.

In another embodiment, the sliding assembly (402) is an adjustable sliding assembly (402) which comprises a threaded tie member (not shown), at least one adjustable sliding member (not shown) and at least one support member (not shown). The adjustable sliding member (not shown) of the adjustable sliding assembly (402) is adapted to be at least partially and movably connected to the threaded tie member (not shown) of the adjustable sliding assembly (402), and at least partially and slidably connected to the first end cover (404). The support member (not shown) of the adjustable sliding assembly (402) is adapted to be connected to the adjustable sliding member (not shown) of the adjustable sliding assembly (402) to support corresponding end of the resilient and shock absorber arrangement (408). To vary the draft of the implement, the adjustable sliding member (not shown) of the adjustable sliding assembly (402) is adapted to be moved with respect to the threaded tie member (not shown) of the adjustable sliding assembly (402) to vary the draft of the implement. The adjustable sliding assembly (402) includes at least one locking element (not shown) for locking the position of the adjustable sliding member (not shown) at the adjusted position (adjusted length) to lock the position of the adjustable sliding assembly (402) at corresponding adjusted position (adjusted length), where the locking element (not shown) is at least one of a threaded nut, a threaded ring, a threaded fastener, a threaded insert, a locking pin and a combination of the above. The sliding movement of the adjustable sliding member (not shown) of the adjustable sliding assembly (402) with the first end cover (404) enables corresponding at least one support member of adjustable sliding assembly (402) to compress at least one resilient and shock absorber arrangement (408) which in turn dampens the shock load received by the implement. In one embodiment, the threaded tie member of the adjustable sliding assembly (402) is at least one of a threaded outer tie rod and a threaded outer tie tube and correspondingly the adjustable sliding member (not shown) of the adjustable sliding assembly (402) is at least one of an adjustable inner sliding rod and an adjustable inner sliding tube. In another embodiment, the threaded tie member of the adjustable sliding assembly (402) is at least one of a threaded inner tie rod and a threaded inner tie tube and correspondingly the adjustable sliding member of adjustable sliding assembly (402) is at least one of an adjustable outer sliding rod and an adjustable outer sliding tube.

In another embodiment, the sliding assembly (402) is at least one of an adjustable and slidable telescopic arrangement, a sliding extendable and retractable arrangement, a slidable and adjustable screw arrangement, a slidable and adjustable arrangement, a slidable linear actuator, a slidable linear adjustable arrangement and a slidable telescopic cylinder arrangement.

The first end cover 404 is used to cover a top side of the housing 406 and to enable a sliding movement of the sliding assembly 402 with respect to the first end cover 404. The first end cover 404 is connected to the housing 406. For the purpose of this description and ease of understanding, the first end cover 404 defines a housing receiving portion (not shown) and a sliding member receiving portion (not shown). The housing receiving portion (not shown) of the first end cover 404 is used to receive a portion of the housing 406 therein to connect the first end cover 404 with the housing 406. In another embodiment, at least a portion of the first end cover 404 can be received by corresponding portion of the housing 406 to connect the first end cover 404 to the housing 406. The sliding member receiving portion (not shown) of the first end cover 404 is used to receive corresponding portion of the sliding member 402S of the sliding assembly 402 to enable sliding movement of the sliding member 402S of the sliding assembly (402) with respect to the end cover 404. The sliding member receiving portion (not shown) of the end cover 404 is at least an opening which is provided at a center of the first end cover 404. The first end cover 404 is a top end cover.

The housing 406 is used to accommodate at least one resilient and shock absorber arrangement 408. The housing 406 is between the first end cover 404 and the second end cover 407. In an embodiment, the housing 406 is configured to be moved with respect to at least one of the first end cover 404 and the second end cover 407 to vary the draft of the implement. The housing 406 has circular cross-section. It is also within the scope of the invention to provide the housing 406 with any other cross-section. The housing 406 is a tubular cylindrical housing. It is also within the scope of the invention to provide the housing (406) as a split housing in which the housing (406) is split into two portions.

The second end cover 407 is used to cover a bottom side of the housing 406 and to enable adjustable movement of the adjustable assembly (410) with respect to the second end cover 407. The second end cover 407 is connected to the housing 406 and disposed opposite to the first end cover 404. For the purpose of this description and ease of understanding, the second end cover 407 defines a support portion (not shown) and an adjustable member receiving portion (not shown). The support portion (not shown) of the second end cover 407 is disposed inside the housing 406. The support portion (not shown) of the second end cover 407 is used to support corresponding another end of at least one resilient and shock absorber arrangement 408. The adjustable member receiving portion (not shown) of the second end cover 407 is used to receive corresponding portion of an adjustable member 410A of the adjustable assembly 410. The adjustable member receiving portion (not shown) of the second end cover 407 is provided with threads. At least one of the first end cover 404 and the second end cover 407 is configured to be moved with respect to the housing 406 to vary the draft of the implement.

The resilient and shock absorber arrangement 408 is used to dampen a shock load received by the implement. The resilient and shock absorber arrangement 408 is adapted to be provided between the sliding assembly 402, and at least one of the second end cover 407 and the adjustable assembly (410), where the resilient and shock absorber arrangement 408 is disposed inside the housing 406. For the purpose of this description an ease of understanding, the resilient and shock absorber arrangement 408 comprises at least one resilient and shock absorber element 408S adapted to be provided inside the housing 406 and loaded between the support member 402M of the sliding assembly 402 and the support portion (not shown) of the second end cover 407. The resilient and shock absorber arrangement 408 is movable between an extended position (initial position) and a compressed position or retracted position to dampen the shock load received by the implement. The resilient and shock absorber element 408S is at least one of a coil spring, a disc spring stack and an elastomer spring. It is also within the scope of the invention to provide any other type of shock absorbing means for absorbing the shock load received by the implement.

In another embodiment, the resilient and shock absorber arrangement (408) includes at least one first resilient and shock absorber element (not shown) and at least one second resilient and shock absorber element (not shown). The first resilient and shock absorber element (not shown) defines one part of the resilient and shock absorber arrangement (408), and the second resilient and shock absorber element (not shown) defines another part of the resilient and shock absorber arrangement (408). In one embodiment, the first resilient and shock absorber element (not shown) is adapted to be provided inside the housing (406) and loaded between the second resilient and shock absorber element, and at least one of the second end cover (407) and the adjustable assembly (410), where the second resilient and shock absorber element (not shown) is adapted to be concentrically loaded onto the first resilient and shock absorber element between the sliding assembly (402). In another embodiment, the first resilient and shock absorber element (not shown) is adapted to be provided inside the housing (406) and loaded between the sliding assembly (402) and at least one of the second end cover (407) and the adjustable assembly (410), where the second resilient and shock absorber element (not shown) is adapted to be concentrically provided inside the first resilient and shock absorber element (not shown), and loaded between the sliding assembly (402) and at least one of the second end cover (407) and the adjustable assembly (410). In another embodiment, the first resilient and shock absorber element (not shown) is adapted to be provided inside the housing (406) and loaded between the sliding assembly (402) and at least one of the second end cover (407) and the adjustable assembly (410), where the second resilient and shock absorber element (not shown) is adapted to be provided parallel to the first resilient and shock absorber element, and loaded between the sliding assembly (402) and at least one of the second end cover (407) and the adjustable assembly (410). In an embodiment, the first resilient and shock absorber element (not shown) is at least one of a coil spring, a disc spring stack and an elastomer spring. In an embodiment, the second resilient and shock absorber element is at least one of a coil spring, a disc spring stack and an elastomer spring.

In another embodiment, the resilient and shock absorber arrangement (408) includes at least one central resilient and shock absorber arrangement (not shown) and a plurality of peripheral resilient and shock absorber elements (not shown). The central resilient and shock absorber arrangement (not shown) is adapted to be provided inside the housing (406) and loaded between the sliding assembly (402), and at least one of the second end cover (407) and the adjustable assembly (410). The plurality of peripheral resilient and shock absorber elements are adapted to be provided outside the central resilient and shock absorber arrangement and loaded between the sliding assembly (402), and at least one of the second end cover (407) and the adjustable assembly (410). Each peripheral resilient and shock absorber element (not shown) is at least one of a coil spring, a disc spring stack and an elastomer spring. It is also within the scope of the invention to provide the resilient and shock absorber arrangement (408) with any other types of shock absorbing means for dampening the shock load received by the implement.

The adjustable assembly 410 is coupled with the implement mounting structure (not shown), and movably connected with the second end cover 407 to vary the draft of the implement. The implement mounting structure (not shown) is at least a hitch. The adjustable assembly 410 is adapted to be at least partially received inside the housing 406 and disposed opposite to the sliding assembly 402. For the purpose of this description and ease of understanding, the adjustable assembly 410 is adapted to be at least partially and movably connected to the second end cover 407, where one end of the adjustable assembly 410 is adapted to be coupled to the implement mounting structure. At least one of the adjustable assembly 410 and the sliding assembly (402) is configured to be moved with respect to the housing 406 to vary the draft of the implement. In an embodiment, the adjustable assembly 410 includes at least one adjustable member 410A. The adjustable member 410A of the adjustable assembly (410) is coupled with the implement mounting structure, and movably connected with the adjustable member receiving portion (not shown) of the second end cover 407. A portion of the adjustable member 410A is provided with a plurality of external threads. To adjust the draft of the implement, the adjustable member 410A is moved with respect to the second end cover 407 to vary the draft of the implement. The adjustable member 410A is at least one of a threaded tie rod and a threaded tie tube. The adjustable assembly 410 includes at least one locking element for locking the position of the adjustable member (410A) at the adjusted position (adjusted length), where the locking element (not shown) is at least one of a threaded nut (not shown), a threaded ring (not shown), a threaded fastener, a threaded insert (not shown), a locking pin (not shown) and a combination of the above. In another embodiment, the adjustable assembly (410) includes at least one support member (not shown) adapted to be connected to the adjustable member (410A), where the support member (not shown) is used to support corresponding another end of at least one resilient and shock absorber arrangement (408).

In another embodiment, the adjustable assembly (410) comprises a rotatable center member (not shown) and a plurality of adjustable members (not shown). The plurality of adjustable members comprises at least one first adjustable member (not shown) and at least one second adjustable member (not shown). The first adjustable member (not shown) is adapted to be coupled to the implement mounting structure and at least partially and movably connected to the rotatable center member (not shown) of the adjustable assembly (410). The second adjustable member (not shown) is adapted to be at least partially and movably connected to the rotatable center member (not shown) and the second end cover (407). The second adjustable member (not shown) is opposite to the first adjustable member (not shown) of the adjustable assembly (410). To adjust the draft of the implement, the rotatable center member (not sown) is configured to be moved to move the first adjustable member (not shown) and the second adjustable member (not shown) with respect to the rotatable center member (not shown) to vary the draft of the implement. The adjustable assembly (410) includes a plurality of locking elements (not shown) for locking the position of the first adjustable member (not shown) and the second adjustable member (not shown) at corresponding adjusted positions (adjusted length) to lock the adjustable assembly (410) at corresponding position (adjusted length), where the locking element (not shown) is at least one of a threaded nut, a threaded ring, a threaded fastener, a threaded insert, a locking pin and a combination of the above. In another embodiment, the adjustable assembly (410) comprises at least one support member (not shown) adapted to be connected to the second adjustable member (not shown) of the adjustable assembly (410) at corresponding predetermined position. The support member of the adjustable assembly (410) is used to support the corresponding another end of at least one resilient and shock absorber arrangement (408). In an embodiment, the rotatable center member of the adjustable assembly (410) is at least one of a rotatable center outer tube and a rotatable center outer rod, and correspondingly the first adjustable member (not shown) of the adjustable assembly (410) is at least one of an adjustable inner tie rod and an adjustable inner tie tube, and the second adjustable member of the adjustable assembly (410) is at least one of an adjustable inner rod and an adjustable inner tube. In another embodiment, the rotatable center member of the adjustable assembly (410) is at least one of a rotatable center inner tube and a rotatable center inner rod, and correspondingly the first adjustable member (not shown) of the adjustable assembly (410) is at least one of an adjustable outer tie rod and an adjustable outer tie tube, and the second adjustable member (not shown) of the adjustable assembly (410) is at least one of an adjustable outer rod and an adjustable outer tube.

In another embodiment, the adjustable assembly (410) comprises a threaded tie member (not shown) and at least one adjustable member (not shown). The threaded tie member (not shown) of the adjustable assembly (410) is coupled with the implement mounting structure. The adjustable member (not shown) of the adjustable assembly (410) is adapted to be at least partially and movably connected to the threaded tie member (not shown) and the second end cover (407). To adjust the draft of the implement, adjustable member (not shown) of the adjustable assembly (410) is configured to be moved with respect to the threaded tie member (not shown) of the adjustable assembly (410) to vary the draft of the implement. The adjustable assembly (410) includes at least one locking element (not shown) for locking the position of the adjustable member (not shown) at corresponding adjusted position (adjusted length) to lock the adjustable assembly (410) at corresponding position (adjusted length), where the locking element (not shown) is at least one of a threaded nut, a threaded ring, a threaded fastener, a threaded insert, a locking pin and a combination of the above. In another embodiment, the adjustable assembly (410) includes at least one support member (not shown) adapted to be connected to the adjustable member (not shown) of the adjustable assembly (410). The support member (not shown) of the adjustable assembly (410) is adapted to support corresponding another end of the resilient and shock absorber arrangement (408). In an embodiment, the threaded tie member (not shown) of the adjustable assembly (410) is at least one of a threaded outer tie rod and a threaded outer tie tube and correspondingly the adjustable member (not shown) of the adjustable assembly (410) is at least one of an adjustable inner rod and an adjustable inner tube. In another embodiment, the threaded tie member of the adjustable assembly (410) is at least one of a threaded inner tie rod and a threaded inner tie tube, and correspondingly the adjustable member (not shown) of the adjustable assembly (410) is at least one of an adjustable outer rod and an adjustable outer tube.

In another embodiment, the adjustable assembly (410) is at least one a telescopic adjustable arrangement, an adjustable extendable and retractable arrangement, an adjustable screw arrangement, an adjustable linear actuator, and a linear adjustable arrangement.

For the purpose of this description and ease of understanding, the working of the draft control mechanism 400 according to corresponding embodiment is as follows. When there is requirement to vary the draft of the implement, the operator moves the adjustable member 410A of the adjustable assembly 410 with respect to the second end cover 407 to change the position of the adjustable member 410A therein to vary the draft of the implement to regulate corresponding depth operation of the implement.

Therefore, a draft control mechanism 400 for varying the draft of an implement, and to dampen a shock load received by the implement when the implement is being towed by a vehicle in agricultural fields is provided.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

We claim:

1. A draft control mechanism 400 for controlling the draft of an implement coupled to an implement mounting structure of a vehicle, said mechanism 400 comprising:
at least one housing 406;
at least one sliding assembly 402 adapted to be at least partially and slidably received inside said housing 406; and
at least one adjustable assembly 410 adapted to be at least partially received inside said housing 406 and disposed opposite to said sliding assembly 402,
wherein
at least one of said adjustable assembly 410 and said sliding assembly (402) is configured to be moved with respect to said housing 406 to vary the draft of the implement.

2. The mechanism 400 as claimed in claim 1 comprises at least one resilient and shock absorber arrangement 408 adapted to dampen a shock load received by the implement.

3. The mechanism 400 as claimed in claim 2 comprises,
a first end cover 404 adapted to be connected to said housing 406; and
a second end cover 407 adapted to connected to said housing 406 and disposed opposite to said first end cover 404.

4. The mechanism 400 as claimed in claim 3, wherein said resilient and shock absorber arrangement 408 is adapted to be provided between said sliding assembly 402, and at least one of said second end cover 407 and said adjustable assembly (410).

5. The mechanism 400 as claimed in claim 4, wherein said sliding assembly 402 is adapted to be at least partially and slidably connected to said first end cover 404.

6. The mechanism 400 as claimed in claim 5, wherein said adjustable assembly 410 is adapted to be at least partially and movably connected to said second end cover 407,
wherein
one end of said adjustable assembly 410 is adapted to be coupled to the implement mounting structure.

7. The mechanism 400 as claimed in claim 6, wherein at least one of said first end cover (404) and said second end cover (407) is configured to be moved with respect to said housing (406) to vary the draft of the implement.

8. The mechanism 400 as claimed in claim 3, wherein said housing (406) is configured to be moved with respect to at least one of said first end cover (404) and said second end cover (407) to vary the draft of the implement.

9. The mechanism 400 as claimed in claim 5, wherein said sliding assembly 402 comprises,
at least one sliding element 402S adapted to be at least partially and slidably connected to said first end cover 404; and
at least one support member 402M adapted to be connected to said sliding element 402S to support corresponding end of said resilient and shock absorber arrangement 408.

10. The mechanism 400 as claimed in claim 9, wherein said resilient and shock absorber arrangement 408 comprises at least one resilient and shock absorber element 408S adapted to be provided inside said housing 406 and loaded between said support member 402M of said sliding assembly 402 and said second end cover 407.

11. The mechanism 400 as claimed in claim 6, wherein said adjustable assembly 410 comprises,
at least one adjustable member 410A adapted to be coupled to the implement mounting structure, and at least partially and movably connected to said second end cover 407,
wherein
said adjustable member 410A is adapted to be moved with respect to said second end cover 407 to vary the draft of the implement.

12. The mechanism 400 as claimed in claim 11, wherein said adjustable assembly (410) comprises,
at least one support member adapted to be connected to said adjustable member (410A),
wherein
said support member is adapted to support corresponding another end of said resilient and shock absorber arrangement (408).

13. The mechanism 400 as claimed in claim 5, wherein said sliding assembly 402 is an adjustable sliding assembly (402) comprising,
a rotatable center member;
at least one adjustable member adapted to be at least partially and movably connected to said rotatable center member;
at least one adjustable sliding member adapted to be at least partially and movably connected to said rotatable center member, and at least partially and slidably connected to said first end cover (404); and
at least one support member adapted to be connected to said adjustable sliding member to support corresponding end of said resilient and shock absorber arrangement (408),
wherein
said rotatable center member is configured to be moved to move said adjustable member and said adjustable sliding member with respect to said rotatable center member to vary the draft of the implement.

14. The mechanism 400 as claimed in claim 5, wherein said sliding assembly 402 is an adjustable sliding assembly (402) comprising,
a threaded tie member;
at least one adjustable sliding member adapted to be at least partially and movably connected to said threaded tie member, and at least partially and slidably connected to said first end cover (404); and
at least one support member adapted to be connected to said adjustable sliding member to support corresponding end of said resilient and shock absorber arrangement (408),
wherein
said adjustable sliding member is adapted to be moved with respect to said threaded tie member to vary the draft of the implement.

15. The mechanism 400 as claimed in claim 5, wherein said sliding assembly (402) is at least one of an adjustable and slidable telescopic arrangement, a sliding extendable and retractable arrangement, a slidable and adjustable screw arrangement, a slidable and adjustable arrangement, a slidable linear actuator, a slidable linear adjustable arrangement, and a slidable telescopic cylinder arrangement.

16. The mechanism 400 as claimed in claim 6, wherein said adjustable assembly (410) comprises,
a rotatable center member; and
a plurality of adjustable members comprising at least one first adjustable member adapted to be coupled to the implement mounting structure and at least partially and movably connected to said rotatable center member, and at least one second adjustable member adapted to be at least partially and movably connected to said rotatable center member and said second end cover (407),
wherein
said rotatable center member is configured to be moved to move said first adjustable member and said second adjustable member with respect to said rotatable center member to vary the draft of the implement.

17. The mechanism 400 as claimed sin claim 16, wherein said adjustable assembly (410) comprises,
at least one support member adapted to connected to said second adjustable member,
wherein
said support member is adapted to support corresponding another end of said resilient and shock absorber arrangement (408).

18. The mechanism 400 as claimed in claim 6, wherein said adjustable assembly (410) comprises,
a threaded tie member adapted to be coupled to the implement mounting structure; and
at least one adjustable member adapted to be at least partially and movably connected to said threaded tie member and said second end cover (407),
wherein
said adjustable member is configured to be moved with respect to said threaded tie member to vary the draft of the implement.

19. The mechanism 400 as claimed in claim 18, wherein said adjustable assembly (410) comprises,
at least one support member adapted to be connected to said adjustable member to support corresponding another end of said resilient and shock absorber arrangement (408).

20. The mechanism 400 as claimed in claim 6, wherein said adjustable assembly (410) is at least one of a telescopic adjustable arrangement, an adjustable extendable and retractable arrangement, an adjustable screw arrangement, an adjustable linear actuator, and a linear adjustable arrangement.

21. The mechanism 400 as claimed in claim 3, wherein said resilient and shock absorber arrangement (408) comprises,
a first resilient and shock absorber element; and
a second resilient and shock absorber element.

22. The mechanism 400 as claimed in claim 22, wherein said first resilient and shock absorber element is adapted to be provided inside said housing (406) and loaded between said second resilient and shock absorber element, and at least one of said second end cover (407) and said adjustable assembly (410),
said second resilient and shock absorber element is adapted to be concentrically loaded onto said first resilient and shock absorber element between said sliding assembly (402).

23. The mechanism 400 as claimed in claim 22, wherein said first resilient and shock absorber element is adapted to be provided inside said housing (406) and loaded between said sliding assembly (402) and at least one of said second end cover (407) and said adjustable assembly (410),
said second resilient and shock absorber element is adapted to be concentrically provided inside said first resilient and shock absorber element and loaded between said sliding assembly (402) and at least one of said second end cover (407) and said adjustable assembly (410).

24. The mechanism 400 as claimed in claim 22, said first resilient and shock absorber element is adapted to be provided inside said housing (406) and loaded between said sliding assembly (402) and at least one of said second end cover (407) and said adjustable assembly (410),
said second resilient and shock absorber element is adapted to be provided parallel to said first resilient and shock absorber element and loaded between said sliding assembly (402) and at least one of said second end cover (407) and said adjustable assembly (410).

25. The mechanism 400 as claimed in claim 3, wherein said resilient and shock absorber arrangement (408) comprises,
at least one central resilient and shock absorber arrangement adapted to be provided inside said housing (406) and loaded between said sliding assembly (402), and at least one of said second end cover (407) and said adjustable assembly (410); and
a plurality of peripheral resilient and shock absorber element adapted to be provided outside said central resilient and shock absorber arrangement and loaded between said sliding assembly (402), and at least one of said second end cover (407) and said adjustable assembly (410).
